(19) United States
(12) Patent Application Publication
(10) Pub. No.: US 2007/0100072 A1
(43) Pub. Date: May 3, 2007

(54) Silicone rubber composition

(76) Inventors: Hiroshi Akitomo, Chiba prefecture (JP); Richard LeRoy Cole, Avon Park, FL (US); Michael Andrew Lutz, Hope, MI (US); Stephen Paul Swanson, Brea, CA (US); Hyung II Yang, ChoongBuk (KR)

Correspondence Address: DOW CORNING CORPORATION CO1232, 2200 W. SALZBURG ROAD, P.O. BOX 994, MIDLAND, MI, 48686-0994, US

(21) Appl. No.: 10/553,820

(22) PCT Filed: Jul. 19, 2004
(86) PCT No.: PCT/US04/23266

§ 371 Date: Oct. 19, 2005

Related U.S. Application Data
(60) Provisional application No. 60/490,172, filed on Jul. 25, 2003.

(51) Int. Cl. C08L 53/00

(52) U.S. Cl. 525/92 G

(57) ABSTRACT

A silicone rubber composition exhibiting superior adhesive properties with respect to organic resins it comes into contact with during its cure, while at the same time possessing superior mold release properties with respect to metal dies used for its molding, contains: (A) a polyorganosiloxane having at least two silicon-bonded alkenyl groups per molecule; (B) a polyorganosiloxane having at least two silicon-bonded hydrogen atoms per molecule; (C) an alkylene glycol ester of diacrylic acid or an alkylene glycol ester of dimethacrylic acid having the formula (1), wherein R1 is hydrogen or a methyl group, R2 represents an alkylene group, and n has a value of 1-10; and (D) a platinum catalyst.

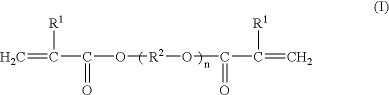

This invention is related to a silicone rubber composition exhibiting superior adhesive properties with respect to organic resins it comes into contact with during its cure; while at the same time possessing superior mold release properties with respect to metal dies used for its molding. The characteristic feature of the silicone rubber composition is that it contains an adhesion/mold release agent consisting of an alkylene glycol ester of diacrylic acid or an alkylene glycol ester of dimethacrylic acid

It is known to adhere silicone rubbers to organic resins by priming one piece of a pre-molded organic resin, contacting its priming surface with a silicone rubber, and then curing them together. However, such methods require separate steps including applying the primer and then drying the resulting two pieces composition. In addition, it has been found that in many instances, sufficient adhesive properties could not be obtained according to this procedure, since the priming treatment was often inadequate.

In order to overcome these disadvantages, especially in order to eliminate the priming step, silicone rubber compositions were developed, which on the one hand, exhibit superior adhesive properties with respect to organic resins they contact during curing, while on the other hand, possessing superior mold release properties with respect to metal dies used when the silicone rubber composition is molded. One example of such a silicone rubber composition is described in detail in U.S. Pat. No. 5,405,896 (Apr. 11, 1995). However, because the silicone rubber composition in the '896 patent contains an adhesion/mold release agent which includes silicon-bonded hydrogen atoms in its molecule, its mold release properties with respect to metal dies used in molding decreases when the silicone rubber composition is used in two-color molding applications, or for insert molding of organic resins in injection molds.

Silicone rubber compositions containing methacrylic acid ester compounds and/or acrylic acid ester compounds are known and are described in U.S. Pat. No. 6,274,658 (Aug. 14, 2001). However, due to their high melting point, these compounds tend to cause non-homogeneities in the system, and result in inferior adhesive properties. In addition, the focus of the '658 patent is to (i) improve the curing rate of silicone rubber compositions, and (ii) improve their storage stability; rather than develop superior adhesive properties with respect to organic resins they contact during cure, and at the same time, possess superior mold release properties with respect to metal dies used when they are molded.

Silicone rubber compositions containing acrylate compounds and/or methacrylate compounds are also known, and are described in U.S. Pat. No. 5,248,715 (Sep. 28, 1993). However, the compounds in the '715 patent are (i) acrylic acid esters containing alkyl, alkenyl, or aryl groups, and/or (ii) methacrylic acid esters containing alkyl, alkenyl, or aryl groups; rather than alkylene glycol esters of diacrylic acid and/or alkylene glycol esters of dimethacrylic acid, according to the present invention. In addition, the silicone rubber compositions in the '715 patent were developed to exhibit strong adhesion to metals; a purpose opposite to purpose herein, i.e., to exhibit superior adhesion to organic resins, and to exhibit mold release with respect to metal dies.

It is an object of the present invention to provide a silicone rubber composition having superior adhesive properties with respect to organic resins contacted during its curing process, and that possesses superior mold release properties to the metal dies used when the silicone rubber composition is molded.

In particular, the invention is directed to a silicone rubber composition comprising:

(A) 100 parts by weight of a polyorganosiloxane having at least two silicon-bonded alkenyl groups per molecule;

(B) a polyorganosiloxane having at least two silicon-bonded hydrogen atoms per molecule, wherein the amount of (B) is the amount at which the ratio of the mole number of the silicon-bonded hydrogen atoms in (B), to the sum of the mole numbers of silicon-bonded alkenyl groups in (A) and unsaturated groups in alkylene glycol ester (C), is 0.5-20;

(C) 0.01-20 parts by weight per 100 parts by weight of (A) of an alkylene glycol ester of diacrylic acid or an alkylene glycol ester of dimethacrylic acid, that is a liquid at 25° C., and is represented by the formula: 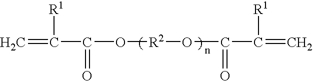
wherein R¹ is hydrogen or a methyl group, R² is an alkylene group, and n has a value of 1-10; and

(D) 0.01-500 parts by weight per 1,000,000 parts by weight of (A) of a platinum-based catalyst.

These and other features of the invention will become apparent from a consideration of the detailed description.

### DESCRIPTION

As noted above, the silicone rubber composition of the present invention contains:

(A) a polyorganosiloxane having at least two silicon-bonded alkenyl groups per molecule;

(B) a polyorganosiloxane having at least two silicon-bonded hydrogen atoms per molecule;

(C) an alkylene glycol ester of diacrylic acid or an alkylene glycol ester of dimethacrylic acid compound having the formula: 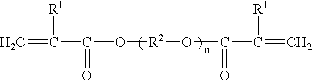
wherein R¹ is hydrogen or a methyl group, R² represents an alkylene group, and n has a value of 1-10; and

(D) a platinum catalyst.

Polyorganosiloxane (A) is the major ingredient of the silicone rubber composition, and it is characterized by having at least two silicon-bonded alkenyl groups per molecule. The molecular structure of (A) is preferably linear, but it may also be linear with a partial branch structure. The silicon-bonded alkenyl groups of (A) are exemplified by vinyl groups, allyl groups, butenyl groups, hexenyl groups, and heptenyl groups, with the vinyl or hexenyl groups being preferred. There are no limitations on the bond position of the alkenyl groups, and it may reside at the terminal ends of the molecular chain, in the side chains of the molecular chain, or in both.

Polyorganosiloxane (A) may contain silicon-bonded groups other than alkenyl groups including alkyl groups such as methyl, ethyl, propyl, butyl, and octyl; aryl groups such as phenyl and tolyl; halogenated alkyl groups such as 3-chloropropyl and 3,3,3-trifluoropropyl; and other substituted or unsubstituted monovalent hydrocarbon groups that do not have aliphatic unsaturated carbon-carbon bonds; with the methyl group being most preferred. There are no limitations on the viscosity of (A) other than it should preferably be in the range of 10-1,000,000 mPa·s (centistoke) at 25° C.

Polyorganosiloxane (A) may comprise a mixture of (i) a polyorganosiloxane (A-1) having at least two silicon-bonded vinyl groups per molecule, and (ii) a polyorganosiloxane (A-2) having at least two silicon-bonded alkenyl groups other than vinyl per molecule. It has been found that such mixtures improve the adhesive properties of the silicone rubber composition with respect to organic resins it contacts during its cure without impairing its mold release properties with respect to metal dies used when it is molded. Hexenyl groups are most preferred as the other alkenyl group in (A-2).

In this regard, polyorganosiloxane (A) is preferably a mixture of polyorganosiloxane (A-1) and (A-2) in which the weight ratio of (A-1):(A-2) is in the range of 1:99 to 99:1; more preferably a polyorganosiloxane mixture in which the weight ratio is 10:90 to 99:1; especially a polyorganosiloxane mixture in which the weight ratio is 50:50 to 99:1. If the weight ratio of (A-1) to (A-2) exceeds the upper limit of the range, the mechanical strength of the silicone rubber composition tends to decrease.

There are no limitations on the viscosity of polyorganosiloxane (A-1) but its viscosity at 25° C. should preferably be in the range of 10-1,000,000 mPa·s (centistoke). Some preferred examples of (A-1) include polydimethylsiloxane having both ends of the molecular chain terminated by dimethylvinylsiloxy groups; a copolymer of methylvinylsiloxane and dimethylsiloxane having both ends of the molecular chain terminated by trimethylsiloxy groups; a copolymer of methylvinylsiloxane and dimethylsiloxane having both ends of the molecular chain terminated by dimethylvinylsiloxy groups; a copolymer of methylphenylsiloxane and dimethylsiloxane having both ends of the molecular chain terminated by dimethylvinylsiloxy groups; and a copolymer of methyl(3,3,3-trifluoropropyl)siloxane and dimethylsiloxane having both ends of the molecular chain terminated by dimethylvinylsiloxy groups.

Similarly, there are no limitations on the viscosity of polyorganosiloxane (A-2) but its viscosity at 25° C. should preferably be in the range of 10-1,000,000 mPa·s (centistoke). Some preferred examples of (A-2) include polydimethylsiloxane having both ends of the molecular chain terminated by dimethylhexenylsiloxy groups; a copolymer of methylhexenylsiloxane and dimethylsiloxane having both ends of the molecular chain terminated by trimethylsiloxy groups; a copolymer of methylhexenylsiloxane and dimethylsiloxane having both ends of the molecular chain terminated by dimethylhexenylsiloxy groups; a copolymer of methylhexenylsiloxane and dimethylsiloxane having both ends of the molecular chain terminated by dimethylvinylsiloxy groups; a copolymer of methylphenylsiloxane and dimethylsiloxane having both ends of the molecular chain terminated by dimethylhexenylsiloxy groups; and a copolymer of methyl(3,3,3-trifluoropropyl)siloxane and dimethylsiloxane having both ends of the molecular chain terminated by dimethylhexenylsiloxy groups.

Polyorganosiloxane (B) is the cross-linking agent used for crosslinking with polyorganosiloxane (A). Polyorganosiloxane (B) should have at least two silicon-bonded hydrogen atoms per molecule. When there are two alkenyl groups per molecule in (A), then polyorganosiloxane (B) should have at least three silicon-bonded hydrogen atoms per molecule, or a mixture of a polyorganosiloxane having at least three silicon-bonded hydrogen atoms per molecule, and a polyorganosiloxane containing two silicon-bonded hydrogen atoms per molecule. There are no limitations on the molecular structure of polyorganosiloxane (B), and (B) can be linear, linear with partial branching, branched, cyclic, or dendritic. In addition, there are no limitations on the bond position of the silicon-bonded hydrogen atoms which can be at the terminal ends of the molecular chain, in the side chains of the molecular chain, or in both.

Polyorganosiloxane (B) may contain silicon-bonded groups other than silicon-bonded hydrogen atoms including alkyl groups such as methyl, ethyl, and propyl; aryl groups such as phenyl and tolyl; halogenated alkyl groups such as chloromethyl, 3-chloropropyl, and 3,3,3-trifluoropropyl; and other substituted or unsubstituted monovalent hydrocarbon groups that do not have aliphatic unsaturated carbon-carbon bonds. While, there are no limitations on the viscosity of polyorganosiloxane (B), it should be in the range of 1-10,000 mPa·s (centistoke) at 25° C.

The amount of polyorganosiloxane (B) used in the silicone rubber composition is the amount at which the ratio of the mole numbers of silicon-bonded hydrogen atoms in (B) to the sum of the mole numbers of silicon-bonded alkenyl groups in polyorganosiloxane (A) and unsaturated groups in alkylene glycol ester (C) is in the range of 0.5-20. Preferably, the amount is such that the ratio is 0.5-5. When the amount of (B) is less than the lower limit of the range, the resulting silicone rubber composition tends to fail to fully cure. When the amount of (B) exceeds the upper limit of the range, the mechanical strength of the silicone rubber composition tends to decrease.

Polyorganosiloxane (B) can consist of a mixture of a polyorganosiloxane (B-1) having at least three silicon-bonded hydrogen atoms per molecule, and a polyorganosiloxane (B-2) having silicon-bonded hydrogen atoms residing only at the two terminal ends of the chain. The use of such a mixture has been found to improve the adhesive properties of the silicone rubber composition with respect to organic resins it contacts during its cure, without impairing its mold release properties with respect to metal dies used when it is molded. The use of such a mixture also allows for a reduction in the amount of the alkylene glycol ester (C) required.

When a mixture is used, polyorganosiloxane (B-1) is present in an amount at which the ratio of the mole numbers of silicon-bonded hydrogen atoms in (B-1) to the sum of the mole numbers of silicon-bonded alkenyl groups in polyorganosiloxane (A) and unsaturated groups in the alkylene glycol ester (C), is in the range of 0.5-20, more preferably in the amount at which the ratio is 0.5-5. When the amount of (B-1) is less than the lower limit of the range, the resulting silicone rubber composition tends to fail to fully cure. When the amount of (B-1) exceeds the upper limit of the range, the mechanical strength of the silicone rubber composition tends to decrease.

The amount of polyorganosiloxane (B-2) in the mixture is preferably the amount at which the ratio of the mole numbers of silicon-bonded hydrogen atoms in (13-2) to the sum of the mole numbers of silicon-bonded alkenyl groups in polyorganosiloxane (A) and unsaturated groups in alkylene glycol ester (C) is 0.01-10, more preferably a ratio of 0.01-5. When the amount of (B-2) is less than the lower limit of the range, the silicone rubber composition tends to fail to sufficiently exhibit its adhesive properties with respect to organic resins it contacts during its cure. When the amount of (B-2) exceeds the upper limit of the range, the mechanical strength of the silicone rubber composition tends to decrease.

While there are no limitations on the viscosity of polyorganosiloxane (B-1), it should be 1-10,000 mPa·s. (centistoke) at 25° C. Polyorganosiloxane (B-1) is exemplified by polymethylhydrogensiloxanes having both ends of their molecular chain terminated by trimethylsiloxy groups; copolymers of methylhydrogensiloxane and dimethylsiloxane having both ends of their molecular chain terminated by trirethylsiloxy groups; copolymers of methylhydrogensiloxane and dimethylsiloxane having both ends of their molecular chain terminated by dimethylhydrogensiloxy groups; cyclic dimethylsiloxane-methylhydrogensiloxane copolymers; cyclic polymethylhydrogensiloxanes; polyorganosiloxanes containing siloxane units represented by (CH₃)₃SiO_{1/2}, siloxane units represented by (CH₃)₂HSiO_{1/2}, and siloxane units represented by SiO_{4/2}; polyorganosiloxanes containing siloxane units represented by (CH₃)₂HSiO_{1/2} and siloxane units represented by CH₃SiO_{3/2}; polyorganosiloxanes containing siloxane units represented by (CH₃)₂HSiO_{1/2}, siloxane units represented by (CH₃)₂SiO_{2/2}, and siloxane units represented by CH₃SiO_{3/2}; and mixtures of such polyorganosiloxanes.

Similarly, while there are no limitations on the viscosity of polyorganosiloxane (B-2), it should also be 1-10,000 mPa·s. (centistoke) at 25° C. Polyorganosiloxane (B-2) is exemplified by a polydimethylsiloxane having both ends of the molecular chain terminated by dimethylhydrogensiloxy groups; a copolymer of methylphenylsiloxane and dimethylsiloxane having both ends of the molecular chain terminated by dimethylhydrogensiloxy groups; a copolymer of methyl(3,3,3-trifluoropropyl)siloxane and dimethylsiloxane having both ends of the molecular chain terminated by dimethylhydrogensiloxy groups; and mixtures of such polyorganosiloxanes.

Alkylene glycol ester (C) is an alkylene glycol ester of diacrylic acid or an alkylene glycol ester of dimethacrylic acid, and it is the ingredient of the silicone rubber composition which is necessary to improve the adhesive properties of the silicone rubber composition with respect to organic resins it contacts during cure without at the same time causing deterioration in its mold release properties with respect to metal dies used when it is molded. This alkylene glycol ester has a structure generally corresponding to the formula: 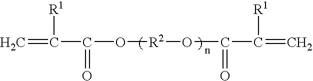
wherein R¹ is hydrogen or a methyl group. R² is a C₁-C₁₀ alkylene group such as methylene, ethylene, propylene, or butylene, preferably a C₂-C₆ alkylene group. Subscript n has a value of 1-10, preferably 1-6. Alkylene glycol esters, which are liquids at 25° C. are preferred in order to ensure handling of alkylene glycol ester (C) during preparation of the silicone rubber composition, and its dispersibility in the silicone rubber composition.

Alkylene glycol ester (C) is exemplified by ethylene glycol diacrylate, diethylene glycol diacrylate, tetraethylene glycol diacrylate, dipropylene glycol diacrylate, tripropylene glycol diacrylate, 1,4-butanediol diacrylate, 1,3-butylene glycol diacrylate, 1,6-hexanediol diacrylate, 1,9-nonanediol diacrylate, 2-n-butyl-2-ethyl-1,3-propanediol diacrylate; ethylene glycol dimethacrylate, diethylene glycol dimethacrylate, tetratethylene glycol dimethacrylate, dipropylene glycol dimethacrylate, tripropylene glycol dimethacrylate, 1,4-butanediol dimethacrylate, 1,3-butylene glycol dimethacrylate, 1,6-hexanediol dimethacrylate, and mixtures thereof

Some preferred examples of alkylene glycol esters (C) are:
I. Ethylene glycol diacrylate 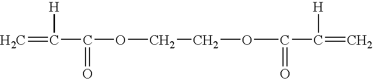
II. Diethylene glycol diacrylate 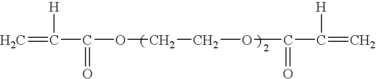
III. Tripropylene glycol diacrylate 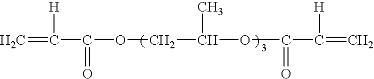
IV. 1,4-butanediol diacrylate 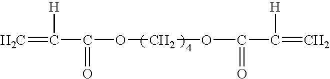
V. 1,6-hexanediol diacrylate 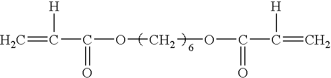
VI. 1,9-nonanediol diacrylate 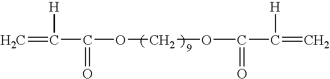
VII. 2-n-butyl-2-ethyl-1,3-propanediol diacrylate 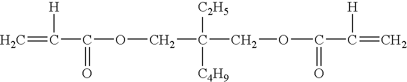
VIII. Ethylene glycol dimethacrylate 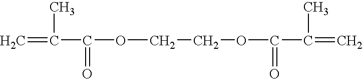
IX. Diethylene glycol dimethacrylate 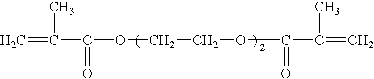
X. 1,4-butanediol dimethacrylate

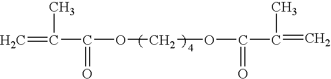

The amount of alkylene glycol ester (C) used in the silicone rubber composition is 0.01-20 parts by weight, preferably, 0.1-10 parts by weight, and more preferably 0.1-5.0 parts by weight, based on 100 parts by weight of polyorganosiloxane (A). When the amount of alkylene glycol ester (C) is less than the lower limit of the range, the silicone rubber composition tends to fail to completely adhere to organic resins it contacts during its cure. When the amount of alkylene glycol ester (C) in the silicone rubber composition exceeds the upper limit of the range, the silicone rubber composition tends to fail to completely cure, and the mechanical strength of cured products tends to decrease.

Platinum catalyst (D) is used for cross-linking polyorganosiloxane (A) and polyorganosiloxane (B) via a hydrosilation reaction. Catalyst (D) is exemplified by platinum micropowder, chloroplatinic acid, alcohol modified derivatives of chloroplatinic acid, chelated compounds of platinum, platinum-diketone complexes, coordination compounds of chloroplatinic acid and olefins, chloroplatinic acid-alkenylsiloxane complexes, and platinum catalysts in which such compositions are supported on alumina, silica, or carbon black. Complexes of chloroplatinic acid and alkenylsiloxanes are preferred because of their high activity in hydrosilation reactions. Most preferred are platinum-alkenylsiloxane complexes as described in U.S. Pat. No. 3,419,593 (Dec. 31, 1968). Spherical micropowders of thermoplastic resins containing not less than 0.01 percent by weight of platinum metal atoms can also be employed.

Catalyst (D) is present in the silicone rubber composition is an amount such that the amount of platinum metal is in the range of 0.01-500 parts by weight, preferably 0.1-100 parts by weight, per 1,000,000 parts by weight of polyorganosiloxane (A).

In addition to polyorganosiloxanes (A) and (B), alkylene glycol ester (C), and platinum catalyst (D), the silicone rubber composition may contain a reinforcing filler (E) of micropowder silica. Filler (13) is beneficial because it is capable of imparting superior mechanical strength to moldings made of the silicone rubber composition, with the result that such silicone rubber moldings can be easily separated from the molding dies. The filler (E) is exemplified by famed silica, dry process silica, precipitated silica, and wet process silica. Filler (E) can have its surface treated with a hydrophobing agent such as an organochlorosilane, an organoalkoxysilane, hexaorganodisilazane, a dimethylhydroxysiloxy terminated polydiorganosiloxane, or a cyclopolydiorganosiloxane. The hydrophobic treatment of filler (E) can be carried out by kneading an untreated filler (E) and one or more of the hydrophobing agents together. A single filler or combination of such fillers can be used.

The Brunauer-Emmett-Teller Nitrogen Adsorption (BET) specific surface area of filler (E) preferably should not be less than 50 m²/g, more preferably not less than 100 m²/g. The amount of filler (E) present in the silicone rubber composition is in the range of 1-100 parts by weight, preferably 5-50 parts by weight, per 100 parts by weight of polyorganosiloxane (A). When the amount of filler (E) is less than the lower limit of the range, the mechanical strength of the silicone moldings obtained by curing the silicone rubber composition is insufficient. When the amount of filler (E) exceeds the upper limit of the range, its mixing with polyorganosiloxane (A) becomes difficult, and the viscosity of the silicone rubber composition becomes excessively high and its handling impaired.

The silicone rubber composition may contain optional ingredients such as inorganic fillers other than micropowder silica filler (E), some examples of which are calcined silica, manganese carbonate, aluminum hydroxide, aluminum oxide, quartz powder, diatomaceous earth, an aluminosilicate, calcium carbonate, and carbon black; pigments such as iron oxide and titanium dioxide; and heat resistant additives such as cerium oxide and cerium hydroxide. The optional inorganic filler can be used in its pure or untreated condition, or its surface can be rendered hydrophobic by treating it with an organoalkoxysilane, an organochlorosilane, or a hexaorganosilazane. The optional inorganic filler can be prepared by kneading it together with one or more of such hydrophobing agents.

The silicone rubber composition may also contain a cure inhibitor in order to improve its handling and storage stability. Some examples of suitable cure inhibitors include acetylenic compounds such as 2-methyl-3-butyne-2-ol, 2-phenyl-3-butyne-2-ol, 3,5-dimethyl-1-hexyne-3-ol, 1-ethynyl-1-cyclohexanol, 1,5-hexadiyne, and 1,6-heptadiyne; ene-yne compounds such as 3,5-dimethyl-1-hexene-1-yne, 3-ethyl-3-butene-1-yne, and 3-phenyl-3-butene-1-yne; alkenylsiloxane oligomers such as 1,3-divinyltetramethyldisiloxane, 1,3,5,7-tetravinyltetramethylcyclotetrasiloxane, and 1,3-divinyl-1,3-diphenyldimethyldisiloxane; ethynyl-containing silicon compounds such as methyltris(3-methyl-1-butyne-3-oxy)silane; nitrogen containing compounds such as tributylamine, tetramethylethylenediamine, and benzotriazole; phosphorous containing compounds such as triphenylphosphine; sulfur-containing compounds; hydroperoxy compounds; maleic acid derivatives; and mixtures thereof.

When included in the silicone rubber composition, the cure inhibitor should be present in an amount of 0.001-3 parts by weight, preferably 0.01-1 part by weight, per 100 parts by weight of polyorganosiloxane (A). Preferred cure inhibitors include the acetylenic compounds described above, and benzotriazole. The cure inhibitor in combination with the platinum catalyst (D), make it possible to balance adequate storage properties with a rapid cure rate of the silicone rubber composition.

Some examples of other optional ingredients that may be included in the silicone rubber composition include (i) dimethylpolysiloxanes having both ends of the molecular chain terminated by trimethylsiloxy groups, dimethylpolysiloxanes having both ends of the molecular chain terminated by dimethylhydroxysiloxy groups, copolymers of methylphenylsiloxane and dimethylsiloxane having both ends of the molecular chain terminated by trimethylsiloxy groups, copolymers of diphenylsiloxane and dimethylsiloxane having both ends of the molecular chain terminated by trimethylsiloxy groups, copolymers of methylphenylsiloxane and dimethylsiloxane having both ends of the molecular chain terminated by dimethylhydroxysiloxy groups, copolymers of methyl(3,3,3-trifluoropropyl)siloxane and dimethylsiloxane having both ends of the molecular chain terminated by trimethylsiloxy groups, and other such polyorganosiloxanes not containing silicon-bonded alkenyl groups and/or silicon-bonded hydrogen atoms; (ii) silicone rubber powders; (iii) silicone resin powders; and (iv) carboxylic acids and metal salts of carboxylic acids such as stearic acid, calcium stearate, and zinc stearate.

The silicone rubber composition is prepared by homogeneously mixing polyorganosiloxane (A), polyorganosiloxane (B), alkylene glycol ester (C), and platinum catalyst (D), and any optional ingredient. When filler (E) is included, it is preferred to first knead polyorganosiloxane (A) and filler (E). A hydrophobic surface treating agent for filler (E) may be included during the kneading process.

Preferably, the silicone rubber composition is stored as a two-part silicone rubber composition consisting of a first part containing polyorganosiloxane (A) and platinum catalyst (D), but not polyorganosiloxane (B); and a second part containing polyorganosiloxane (A) and polyorganosiloxane (B), but not platinum catalyst (D). This two-part system improves the storage stability of the silicone rubber composition at room temperature, and retains its superior curability when using the silicone rubber composition in two-color molding processes.

When the two-part silicone rubber composition is prepared, alkylene glycol ester (C) may be contained in both parts or in either one of the two parts. However, it is most preferred not to include alkylene glycol ester (C) in the part containing the polyorganosiloxane (B), since under some circumstances, it is possible that a reaction may occur between polyorganosiloxane (B) and alkylene glycol ester (C) to change their characteristics, depending on the particular compounds being used and the conditions under which they are stored.

Silicone rubber compositions containing alkylene glycol esters (C) according to the present invention, exhibit superior adhesive properties with respect to (i) saturated polyester resins such as polyethylene terephthalate (PET) and polybutylene terephthalate (PBT); (ii) organic resins such as ABS resins, AS resins, modified polyphenylene ether resins, polyether imide resins, polyphenylene sulfide resins, polyamide resins, polyphthalamide resins, polycarbonate resins (PC), polyacetal resins, acrylic resins, methacrylic resins, polypropylene resins, polystyrene resins, epoxy resins, and polyurethane (PU) resins; (iii) mixtures and alloys of two or more of resins (i) and (ii); and (iv) composite materials consisting of resins (i) and (ii) which are reinforced with glass fiber, carbon fiber, and polyamide fiber.

The silicone rubber composition containing alkylene glycol esters (C) also has superior mold release properties with respect to steel and stainless steel, which are normally used for silicone rubber molding dies, as well as with respect to chrome plated or nickel plated steel materials, or mold materials such as aluminum alloys, which are often used in small-scale production or for prototypes.

For these reasons, the silicone rubber composition herein is suitable for use as a silicone rubber composition for matched metal molding of silicone rubber with organic resins, as in two-color molding processes, often referred to as co-molding, or for insert molding with organic resins in injection molding processes.

The following examples illustrate the invention in more detail. The viscosity used in the examples refers to values obtained at 25° C.

### APPLICATION EXAMPLE 1

A base composition was prepared by mixing (i) 71 parts by weight of a polydimethylsiloxane having both ends of its molecular chain terminated by dimethylvinylsiloxy groups, and having a viscosity of 26,000 mPa·s; (ii) 24 parts by weight of fumed silica with a specific surface area of 380 m²/g; (iii) 4 parts by weight of hexamethyldisilazane as a surface treatment agent for the fumed silica; and (iv) 1 part by weight of water. Ingredients (i) to (iv) were mixed to homogeneity, followed by additional mixing for 2 hours at 170° C. under vacuum, and then the mixture was cooled. 2.2 parts by weight of ethylene glycol dimethacrylate was added to 100 parts by weight of the base composition.

A curable silicone rubber composition was prepared by adding to the base composition, (v) 6.9 parts by weight of a copolymer of methylhydrogensiloxane and dimethylsiloxane having both ends of its molecular chain terminated by trirethylsiloxy groups, and having a viscosity of 5 mPa·s; (vi) 0.04 parts by weight of 1-ethynyl-1-cyclohexanol; and (vii) a sufficient amount of a platinum complex of 1,3-divinyltetramethyldisiloxane, to provide 10 parts by weight of platinum metal per 1,000,000 parts by weight of polyorganosiloxane (i). The amount of copolymer (v) used was the amount at which the ratio of mole numbers of silicon-bonded hydrogen atoms in copolymer (v), to the sum of mole numbers of silicon-bonded vinyl groups in polyorganosiloxane (i), and mole numbers of methacryl groups in ethylene glycol dimethacrylate, was 1.8.

The organic resins shown in Table 1 were placed inside a molding die, the silicone rubber composition was injected on top of the resin in the molding die, and the molding die was heated at 105° C. for 20 minutes to cure the silicone rubber composition. The adhesive properties of the molded silicone rubber article with respect to the organic resins in the molding die during curing, as well as its mold release properties, with respect to steel, i.e., the metal of construction of the mold, were observed, and are shown in Table 1.

The criteria used to evaluate adhesive properties of the silicone rubber article with respect to the organic resins was cohesive failure designated ◯, peeling at the interface designated ×, and serious peeling at the interface designated Δ. The criteria used to evaluate the mold release properties of the silicone rubber article with respect to steel was excellent mold release properties designated ◯, and inferior mold release properties designated ×. Evaluations using these criteria are shown in Table 1.

TABLE 1

| | Application Example 1 |
|---|---|
| Adhesion to organic resins | |
| Nylon resin | ◯ |
| PET resin | ◯ |
| Polyphthalamide resin | ◯ |
| Mold release properties with respect to metal | ◯ |
| Steel used for metal molds | |

### APPLICATION EXAMPLE 2

A base composition was prepared by mixing (i) 90 parts by weight of a polydimethylsiloxane having both ends of its molecular chain terminated by dimethylvinylsiloxy groups, and having a viscosity of 40,000 mPa·s; (ii) 35 parts by weight of fumed silica with a specific surface area of 200 m²/g; (iii) 7 parts by weight hexamethyldisilazane as a surface treatment agent for the silica; and (iv) 2 parts by weight of water. Ingredients (i)-(iv) were mixed to homogeneity, followed by additional mixing for 2 hours at 170° C. under vacuum. After cooling the mixture, (v) 8 parts by weight of a copolymer of methylhexenylsiloxane and dimethylsiloxane having both ends of its molecular chain terminated by trimethylsiloxy groups, having a viscosity of 350 mPa·s, and containing 0.04 mole percent hexenyl groups; and (vi) 1 part by weight of diethylene glycol diacrylate, were added to 100 parts by weight of the base composition,

A curable silicone rubber composition was prepared by adding to the base composition, (vii) 2.2 parts by weight of a copolymer of methylhydrogensiloxane and dimethylsiloxane having both ends of its molecular chain terminated by trimethylsiloxy groups, and having a viscosity of 5 mPa·s; (viii) 3.4 parts by weight of a polydimethylsiloxane having both ends of its molecular chain terminated by dimethylhydrogensiloxy groups, and having a viscosity of 10 mPa·s; (ix) 0.05 parts by weight of 3-methyl-1-hexyne-3-ol; (x) 0.2 parts by weight of calcium stearate; and (xi) a sufficient amount of a platinum complex of 1,3-divinyltetramethyldisiloxane to provide 7 parts by weight of platinum metal per 1,000,000 parts by weight of polyorganosiloxanes (i) and (v). The amount of copolymer (vii) used was the amount at which the ratio of mole numbers of silicon-bonded hydrogen atoms in copolymer (vii), to the sum of mole numbers of silicon-bonded alkenyl groups in polyorganosiloxanes (i) and (v), and mole numbers of acryl groups in diethylene glycol diacrylate, was 1.5. The amount of polyorganosiloxane (viii) used was the amount at which the ratio of mole numbers of silicon-bonded hydrogen atoms in copolymer (viii), to the sum of mole numbers of silicon-bonded alkenyl groups in polyorganosiloxanes (i) and (v), and mole numbers of acryl groups in diethylene glycol diacrylate, was 0.3.

The molding procedure in Application Example 1 was repeated in this example, except that the mold was heated at 120° C. for 3 minutes. The same evaluations and criteria in Application Example I were used in this example, and are shown in Table 2.

### COMPARATIVE EXAMPLE 1

Application Example 2 was repeated, except that diethylene glycol diacrylate was omitted. The molding procedure, evaluations, and criteria, in Application Example 1 were used in this example, and are shown in Table 2.

TABLE 2

| | Application | Comparative |
|---|---|---|
| | Ex. 2 | Ex. 1 |
| Adhesion to organic resins | | |
| PET resin | ◯ | X |
| PBT resin | ◯ | X |
| Polycarbonate resin | ◯ | X |
| Modified polyphenylene ether resin | ◯ | X |
| Mold release properties with respect | | ◯ |
| to metal | | |
| Chrome plated | ◯ | ◯ |
| Nickel plated | ◯ | ◯ |
| Steel sheet | ◯ | ◯ |
| Aluminum | ◯ | ◯ |

### APPLICATION EXAMPLE 3

The base composition in this example was the same as the base composition in Application Example 2, except that ingredient (v) contained methylvinylsiloxane units instead of methylhexenylsiloxane units, and ingredient (vi) was 1,4-butanediol diacrylate.

A curable silicone rubber composition was prepared by adding to the base composition, (vii) 1.7 parts by weight of a copolymer of methylhydrogensiloxane and dimethylsiloxane having both ends of its molecular chain terminated by trimethylsiloxy groups, and having a viscosity of 70 mPa·s; (viii) 4.2 parts by weight of a polydimethylsiloxane having both ends of its molecular chain terminated by dimethylhydrogensiloxy groups, and having a viscosity of 10 mPa·s; (ix) 5 parts by weight of a copolymer of methylphenylsiloxane and dimethylsiloxane having both ends of its molecular chain terminated by trimethylsiloxy groups, having a viscosity of 130 mPa·s, and containing 25 percent dimethylsiloxane units and 75 percent methylphenylsiloxane units; (x) 0.02 parts by weight of benzotriazole; and (xi) a sufficient amount of a platinum complex of 1,3-divinyltetramethyldisiloxane to provide 20 parts by weight of platinum metal per 1,000,000 parts by weight of polyorganosiloxanes (i) and (v). The amount of copolymer (vii) used was the amount at which the ratio of mole numbers of silicon-bonded hydrogen atoms in copolymer (vii), to the sum of mole numbers of silicon-bonded alkenyl groups in polyorganosiloxanes (i) and (v), and mole numbers of acryl groups in 1,4-butanediol diacrylate, was 0.8. The amount of polyorganosiloxane (viii) used was the amount at which the ratio of mole numbers of silicon-bonded hydrogen atoms in copolymer (viii), to the sum of mole numbers of silicon-bonded alkenyl groups in polyorganosiloxanes (i) and (v), and mole numbers of acryl groups in 1,4-butanediol diacrylate, was 0.4.

The molding procedure, evaluations, and criteria, in Application Example 1 were used in this example, and are shown in Table 3.

TABLE 3

| | Application Example 3 |
|---|---|
| Adhesion to organic resins | |
| PET resin | ◯ |
| PBT resin | ◯ |
| Polycarbonate resin | ◯ |
| Modified polyphenylene ether resin | ◯ |
| Acrylic resin | ◯ |
| PPS resin | ◯ |
| Glass fiber-containing epoxy resin | ◯ |
| Mold release properties with respect to metal | |
| Chrome plated | ◯ |
| Nickel plated | ◯ |
| Steel sheet | ◯ |
| Aluminum | ◯ |

### APPLICATION EXAMPLE 4

Application Example 2 was repeated, except that 30 parts by weight of ingredient (v) were used, instead of 8 parts by weight; ingredient (vi) consisted of 1.5 parts by weight of 1,4-butanediol diacrylate, instead of 1 part by weight of diethylene glycol diacrylate; 6 parts by weight of ingredient (vii) were used, instead of 2.2 parts by weight; 0.06 parts by weight of ingredient (ix) were used, instead of 0.05 parts by weight; ingredient (viii) and ingredient (x) were omitted; and 110 parts by weight of the base composition was used, instead of 100 parts by weight.

The molding procedure, evaluations, and criteria, in Application Example 1 were used in this example, and are shown in Table 4.

TABLE 4

| | Application Example 4 |
|---|---|
| Adhesion to polyurethane | ◯ |
| PU resin | |
| Mold release properties with respect to metal | |
| Chrome plated | ◯ |
| Nickel plated | ◯ |
| Steel sheet | ◯ |
| Aluminum | ◯ |

Since the silicone rubber composition of the present invention are characterized by having superior adhesive properties with respect to organic resins contacted during cure, and superior mold release properties with respect metal dies used for molding, the silicone rubber compositions are most suitably adapted for use in two-color molding processes, and in insert molding processes using injection-type molds.

Other variations may be made in compounds, compositions, and methods described herein without departing from the essential features of the invention. The embodiments of the invention specifically illustrated herein are exemplary only and not intended as limitations on their scope except as defined in the appended claims.

1. A silicone rubber composition comprising:
(A) 100 parts by weight of a polyorganosiloxane having at least two silicon-bonded alkenyl groups per molecule;
(B) a polyorganosiloxane having at least two silicon-bonded hydrogen atoms per molecule, wherein the amount of (B) is the amount at which the ratio of the mole number of the silicon-bonded hydrogen atoms in (B), to the sum of the mole number of silicon-bonded alkenyl groups in (A) and unsaturated groups in alkylene glycol ester (C), is 0.5-20;
(C) 0.01-20 parts by weight per 100 parts by weight of (A) of an alkylene glycol ester of diacrylic acid or an alkylene glycol ester of dimethacrylic acid, that is a liquid at 25° C., and is represented by the formula: 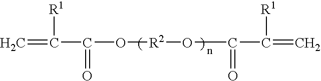
wherein R¹ represents hydrogen atom or a methyl group, R² represents an alkylene group, and n has a value of 1-10; and
(D) 0.01-500 parts by weight per 1,000,000 parts by weight of (A) of a platinum-based catalyst.

2. A composition according to claim 1 additionally comprising 1-100 parts by weight per 100 parts by weight of polyorganosiloxane (A) of a reinforcing micropowder silica filler (E).

3. A composition according to claim 1 in which polyorganosiloxane (A) comprises a mixture of a polyorganosiloxane (A-1) having at least two silicon-bonded vinyl groups per molecule, and a polyorganosiloxane (A-2) having at least two silicon-bonded alkenyl groups other than a vinyl group per molecule, and wherein the weight ratio of (A-1) to (A-2) is 1:99 to 99:1.

4. A composition according to claim 3 in which (A-2) is a polyorganosiloxane having at least two silicon-bonded hexenyl groups per molecule.

5. A composition according to claim 1 in which polyorganosiloxane (B) comprises a mixture of a polyorganosiloxane (B-1) having at least three silicon-bonded hydrogen atoms per molecule, (B-1) being present in an amount wherein the ratio of mole numbers of silicon-bonded hydrogen atoms in (B-1) to the sum of mole numbers of silicon-bonded alkenyl groups in polyorganosiloxane (A) and unsaturated groups in alkylene glycol ester (C) is 0.5-20; and a polyorganosiloxane (B-2) having silicon-bonded hydrogen atoms only at the terminal ends of the molecular chain, (B-2) being present in an amount wherein the ratio of mole numbers of silicon-bonded hydrogen atoms in (B-2) to the sum of mole numbers of silicon-bonded alkenyl groups in polyorganosiloxane (A) and unsaturated groups in alkylene glycol ester (C) is 0.01-10.

6. In a co-molding process or an insert molding process, in which materials are molded, the improvement comprising molding a material which comprises the composition defined in claim 1.
